(19) United States
(12) Patent Application Publication
(10) Pub. No.: US 2004/0254810 A1
(43) Pub. Date: Dec. 16, 2004

(54) System for effectively utilizing users' customer information

(75) Inventors: Hiroyuki Yamaga, Minato-ku (JP); Mikito Hirata, Minato-ku (JP); Tomohiko Asano, Minato-ku (JP); Toru Usami, Minato-ku (JP); Hiroshi Date, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/855,740

(22) Filed: May 28, 2004

(30) Foreign Application Priority Data
May 29, 2003 (JP) 2003-152871

(51) Int. Cl. G06F 17/60; G06K 5/00

(52) U.S. Cl. 705/1; 705/14

(57) ABSTRACT

The customer information utilization system of the present invention includes history acquisition units, history storage units, and history utilization units. The history acquisition units are arranged in each device belonging to users and acquire history information relating to the history of use of the devices. The history storage units collect history information relating to the history of use of each device belonging to the users by way of the history acquisition units and store the history information. When a product or service is to be provided or when an application is to be executed, the history utilization units use appropriate history information of the history information relating to the history of use of each device belonging to the users to produce customer information that is to be utilized in the product, service or application.

### BACKGROUND OF THE INVENTION

1. Field of the Invention

The present invention relates to a customer information utilization system for utilizing users' customer information for products, services, or applications.

2. Description of the Related Art

Users' customer information is conventionally used to offer users better products or services, and various methods have been investigated as methods for acquiring and utilizing users' customer information.

The following methods can be taken as examples of methods of acquiring customer information:

When a user first purchases a product or first uses a service, the user is asked to register his or her attributes or interests.

When a user purchases a product or uses a service, information regarding the purchase of the product or information regarding the use of the service is stored by the provider that provides the product or service.

In addition, methods of utilizing customer information typically analyze customer information and then reflect the findings of the analysis in products or services.

Many methods have been disclosed for acquiring and utilizing users' customer information as described above. One example of such a method is the method for utilizing customer information for the purpose of more effectively promoting purchase that is disclosed in Japanese Patent Laid-Open Publication No. 2002-032553.

However, to provide users with better products or services, the scope of the customer information (items that should be investigated and the content and volume of information that is derived from these items) must be determined precisely. Products or services that have been provided conventionally to users have been simple and uniform, and the limited scope of customer information therefore posed no particular problems.

However, in today's advanced information society, users' values have become more varied and complex, and when acquiring customer information, it has therefore become difficult to determine in advance what products or services will be offered in the future and then determine the content of customer information that is to be acquired.

Given this situation, the acquisition of customer information by first focusing on a specific product or service that is the object of sales promotion as disclosed in the prior art in the above-described patent document inevitably limits the scope of customer information.

Thus, when utilizing customer information that has already been acquired to promote a product or service that was not originally imagined, the acquired customer information will in many cases not necessarily be useful, or information regarding necessary items may be insufficient, and the utilization of the customer information may not produce adequate results.

As for a device that a user owns, the customer information that is acquired by, for example, having the user register is limited in scope. With such device, it frequently happens that, when offering users an application that was not at first contemplated, utilizing users' customer information that is obtained from the application that was the furnished with the device cannot obtain adequate results.

### SUMMARY OF THE INVENTION

It is an object of the present invention to provide a customer information utilization system that effectively utilizes users' customer information and that can offer users better products, services, or applications, including products, services, or applications that were not imagined beforehand.

To achieve the above-described object, the customer information utilization system of the present invention is provided with history utilization means for, when providing a product or service or when executing an application, using appropriate history information of history information that relates to the history of use of each device belonging to users to produce customer information that is utilized for a product, service, or application.

Thus, when offering a new product, service or application that did not previously exist, the necessary history information may be extracted and the customer information produced when the content of this product, service, or application has become clear. Accordingly, a product, service, or application that was not at first contemplated can be offered to users.

In addition, the invention not only provides products, services or applications to users, but can also offer to other providers of products or services precise customer information that these providers require.

Still further, the customer information utilization system of the present invention is also provided with a history storage means for storing history information relating to the history of use of each of various types of equipment belonging to users, and the history utilization means uses this history information to produce customer information.

As a result, customer information can be created that accurately reflects the interests and activities of users that cannot be comprehended solely from the history information of devices alone or services alone.

In addition, a storage means for storing history information for each user and a history extraction means for extracting history information from the storage means for each user are arranged in the customer information utilization system of the present invention, and the storage means of a particular user can be accessed only by the history extraction means that corresponds to that user. In other words, the history extraction means operates with top priority given to protecting the interests of the user.

As a result, the customer information utilization system can utilize history information while deferring to the user's privacy. This effect is more greatly enhanced when the storage means and history extraction means are both physically arranged on the user's side.

The above and other objects, features, and advantages of the present invention will become apparent from the following description with reference to the accompanying drawings, which illustrate examples of the present invention.

### BRIEF DESCRIPTION OF THE DRAWINGS

FIG. 1 shows the configuration of a customer information utilization system according to the first embodiment of the present invention;

FIG. 2 shows an example of devices belonging to particular users;

FIG. 3 shows an example of the history content that is gathered as history information from each device by the history merge/storage unit that is shown in FIG. 1;

FIG. 4 shows an example of a history DB for each user that is shown in FIG. 1;

FIG. 5 is a view for explaining the operation of the customer information utilization system that is shown in FIG. 1;

FIG. 6 is a view for explaining example 1 of the actual utilization of customer information by the customer information utilization system that is shown in FIG. 1;

FIG. 7 shows an example of the extraction conditions designated by a service provider processor in utilization example 1 of the utilization of the customer information that is shown in FIG. 6;

FIG. 8 shows an example of the analysis conditions designated by the service provider processor in utilization example 1 of utilization of the customer information that is shown in FIG. 6;

FIG. 9 shows an example of the history information that is extracted from history DB by history extraction agent in utilization example 1 of the utilization of the customer information that is shown in FIG. 6;

FIG. 10 shows an example of customer information that is created by history utilization agent in utilization example 1 of the utilization of the customer information that is shown in FIG. 6;

FIG. 11 is a view for explaining arrangement for obtaining, from a service provider, compensation for the customer information provided by users in utilization example 1 of the utilization of the customer information that is shown in FIG. 6;

FIG. 12 is a view for explaining utilization example 2 of the actual utilization of customer information by the customer information utilization system that is shown in FIG. 1;

FIG. 13 shows an example of the extraction conditions that are designated by the service provider processor in utilization example 2 of the utilization of customer information that is shown in FIG. 12;

FIG. 14 shows an example of the analysis conditions designated by a service provider processor in utilization example 2 of the utilization of customer information that is shown in FIG. 12;

FIG. 15 shows an example of history information that is extracted from a history DB by history extraction agent in utilization example 2 of the utilization of customer information that is shown in FIG. 12;

FIG. 16 shows an example of the analysis results obtained when history utilization agent analyzes history information, attribute information, and permission information in utilization example 2 of the utilization of customer information that is shown in FIG. 12;

FIG. 17 is a view for explaining utilization example 3 of the actual utilization of customer information by the customer information utilization system that is shown in FIG. 1;

FIG. 18 shows an example of the extraction conditions designated by service provider processor in utilization example 3 of the utilization of customer information that is shown in FIG. 17;

FIG. 19 shows an example of history information that is extracted from history DB by history extraction agent in utilization example 3 of the utilization of customer information that is shown in FIG. 17;

FIG. 20 is a view for explaining utilization example 4 of the actual utilization of customer information by customer information utilization system that is shown in FIG. 1;

FIG. 21 shows an example of the extraction conditions that are designated by the service provider processor in utilization example 4 of the utilization of customer information that is shown in FIG. 20;

FIG. 22 shows an example of the analysis conditions that are designated by service provider processor in utilization example 4 of the utilization of customer information that is shown in FIG. 20;

FIG. 23 shows an example of history information that is extracted from history DB by history extraction agent in utilization example 4 of the utilization of customer information that is shown in FIG. 20;

FIG. 24 shows an example of customer information that is created by history utilization agent in utilization example 4 of the utilization of customer information that is shown in FIG. 20;

FIG. 25 shows the configuration of the customer information utilization system according to the second embodiment of the present invention;

FIG. 26 shows the configuration of the customer information utilization system according to the third embodiment of the present invention;

FIG. 27 shows the configuration of the customer information utilization system according to the fourth embodiment of the present invention; and

FIG. 28 shows the configuration of the customer information utilization system according to the fifth embodiment of the present invention.

### DESCRIPTION OF THE PREFERRED EMBODIMENTS

First Embodiment

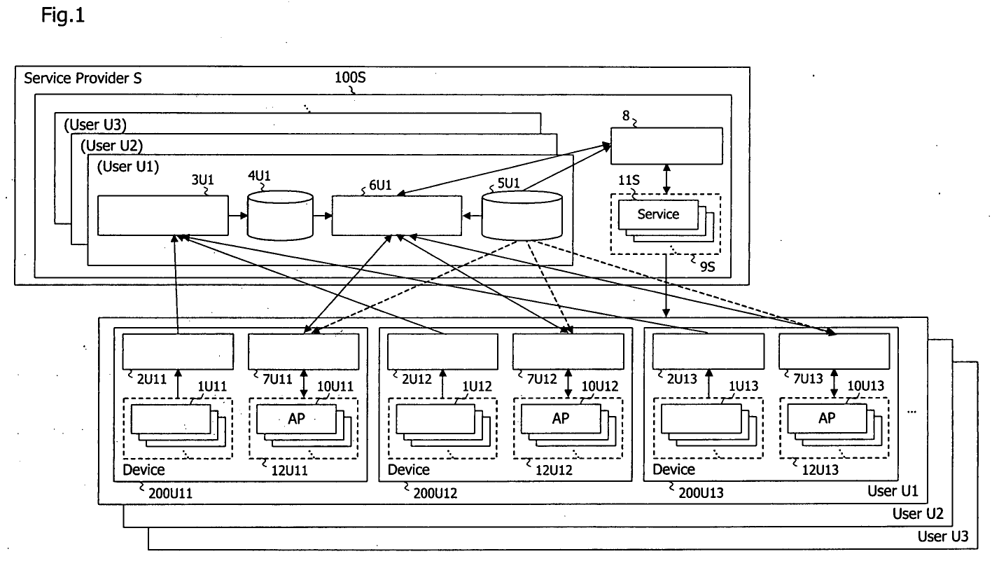

FIG. 1 shows the configuration of the customer information utilization system according to the first embodiment of the present invention.

Referring to FIG. 1, customer information utilization system of the first embodiment of the present invention includes: service provider server 100S belonging to service provider S; and devices 200Uxy (where x=1, 2, 3, . . . , y=1, 2, 3, . . . ) belonging to users Ux. Service provider server 100S need not be one physical server, but may be made up by a plurality of physical servers for the purpose of distributing load or dividing functions.

Service provider server 100S stores the customer information of each of users Ux and is equipped with a function for offering one or more services 11S that utilize the stored customer information and a function for providing the customer information of each user Ux to each device 200Uxy for causing application 10Uxy that is executed in each device 200Uxy to utilize the customer information of each of users Ux. Service provider server 100S may be realized by a typical information processor such as a server, PC (Personal Computer), or supercomputer. Service provider server 100S may also be provided with a function for providing the customer information of each of users Ux to the information processors of other service providers or product providers for causing the customer information of each of users Ux to be utilized in the services or products offered by these other service providers or product providers. Service provider server 100S includes: history merge/storage unit 3Ux, history DB 4Ux that corresponds to the first storage means, attribute/permission DB 5Ux that corresponds to the second storage means, history extraction agent 6Ux, history utilization agent 8, and service provider processor 9S that corresponds to the first customer information request means. In addition, FIG. 1 shows a case in which the information processing environment of each user Ux is virtually separated inside service provider server 100S and does not show the provision of a physical server for each user Ux in service provider server 100S.

Each device 200Uxy is equipped with one or more applications (AP) 10Uxy. In addition, each device 200Uxy can also utilize the customer information of each user Ux in its own application 10Uxy. Each device 200Uxy includes: history acquisition unit 1Uxy, history acquisition agent 2Uxy, history utilization agent 7Uxy, and application execution processor 12Uxy that corresponds to the second customer information request means.

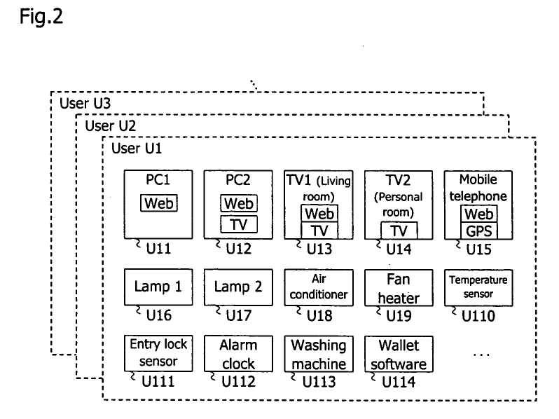

FIG. 2 shows an example of each of devices 200Uxy that belong to particular users Ux.

For example, user U1 owns the variety of devices 200U1y shown in FIG. 2. Each of devices 200Uxy are in turn interconnected by, for example, a home network, and are further connected to service provider server 100S by way of the home network.

At least one history acquisition unit 1Uxy is provided in each of devices 200Uxy that are owned by each of users Ux. History acquisition unit 1UXy acquires a variety of history information such as the state of use of each device 200Uxy or the state of use and setting modification information of service 11S or application 10Uxy on each device 200Uxy. History acquisition unit 1Uxy can also be realized by various sensors or by modules that monitor the state of use of applications and/or services or setting modification states.

History acquisition agent 2Uxy acquires the history information from each of history acquisition units 1Uxy in each of devices 200Uxy belonging to users Ux.

History merge/storage units 3Ux are provided for each of users Ux, gather and merge the history information that has been acquired by history acquisition agents 2Uxy in each of devices 200Uxy belonging to corresponding users Ux, and store the history information in history DB 4Ux for each of users Ux.

History DBs 4Ux are provided for each of users Ux and are databases for storing the history information of each of devices 200Uxy that belong to corresponding users Ux.

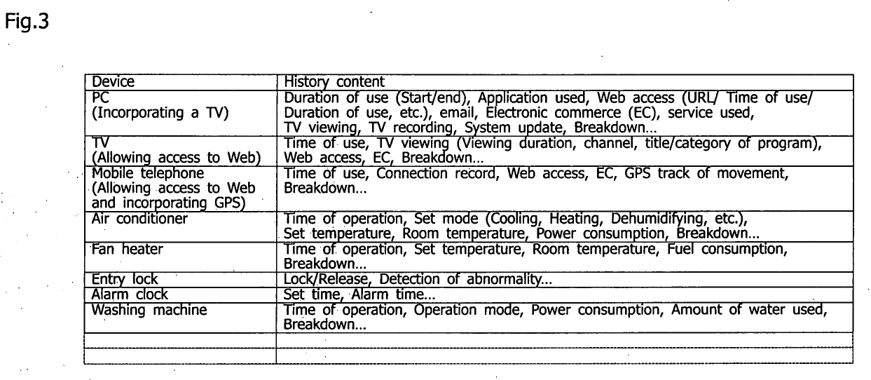

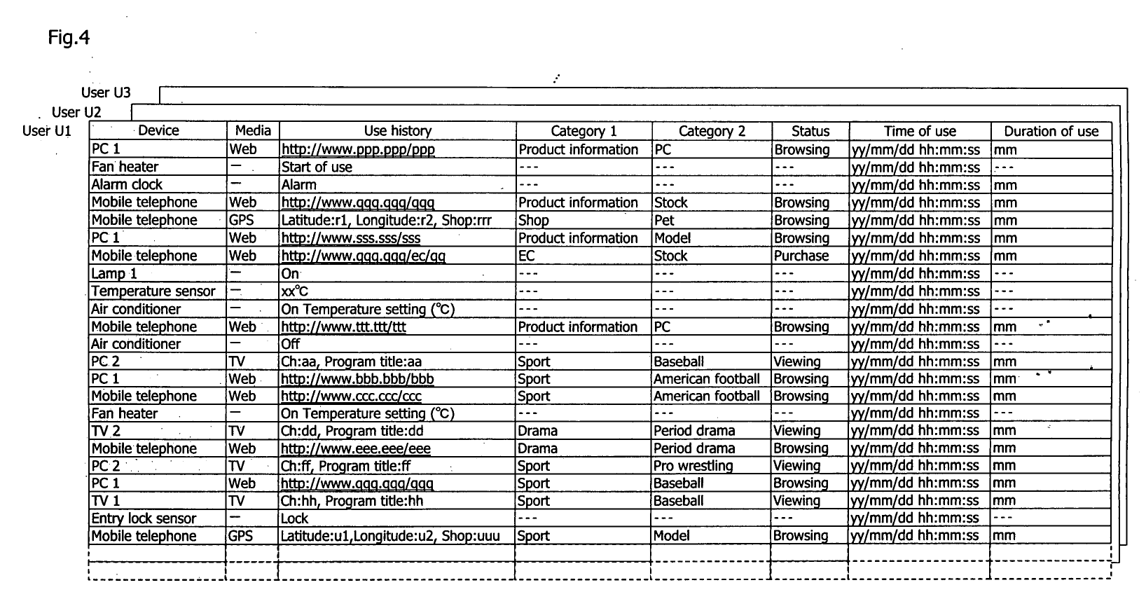

FIG. 3 shows an example of the history content that history merge/storage unit 3Ux shown in FIG. 1 gathers as history information from each of devices 200Ux. In addition, FIG. 4 shows an example of history DB 4Ux for each of users Ux shown in FIG. 1.

History acquisition agent 2Uxy in each of devices 200Uxy acquires history information such as shown in FIG. 3 from each of devices 200Uxy by constantly monitoring each history acquisition unit 1Uxy. History merge/storage unit 3Ux collects this type of history information from history acquisition agent 2Uxy. In addition, history merge/storage unit 3Ux merges and stores the history information that has been collected from history acquisition agent 2Uxy in each of devices 200Uxy into history DB 4Ux for each of users Ux as shown in FIG. 4. Still further, history acquisition agent 2Uxy and history merge/storage unit 3Ux constantly carry out the above-described operations regardless of the existence of a request from service provider processor 9S or application execution processor 12Uxy.

Attribute/permission DB 5Ux is provided for each of users Ux and is a database for storing both the attribute information of the corresponding user Ux and the permission information that has been designated in advance by the corresponding user Ux. Attribute information is basic information such as the residence, email address, and family makeup of users Ux. The permission information is information (such as: the purpose for using attribute information and history information, the method of disclosure, and the range of disclosure) indicating the range of attribute information and history information that each of users Ux permits to provide to service 11S or application 10xy. When customer information is utilized, reference is made to attribute/permission DB 5Ux, and the attribute information and history information are utilized within the range permitted by each of users Ux.

History extraction agent 6Ux is provided for each of users Ux, and extracts from history information that has been stored in history DB 4Ux of corresponding user Ux the history information that is necessary for providing service 11S or executing application 10Uxy. In addition, of the history information of each of users Ux, history extraction agent 6Ux provides to history utilization agents 7Uxy and 8 only information that is within the range permitted by each of users Ux based on permission information that has been extracted from attribute/permission DB 5Ux. In other words, history extraction agent 6Ux has the role of extracting only history information that, from the point of view of user Ux, will not adversely affect the interest of user Ux, and offering this information to history utilization agents 7Uxy and 8.

Application execution processor 12Uxy in each of devices 200Uxy is equipped with various functions for executing applications 10Uxy. For example, application execution processor 12Uxy is equipped with a function for executing application 10Uxy, a function for requesting history utilization agent 7Uxy to obtain the customer information of user Ux, and a function for receiving the customer information of user Ux from history utilization agent 7Uxy when application 10Uxy is to be executed.

When application 10Uxy is to be executed, history utilization agent 7Uxy in each of devices 200Uxy executes the following processes based on a request from application execution processor 12Uxy:

a process for instructing history extraction agent 6Ux to extract history information;

a process for extracting permission information from attribute/permission DB 5Ux;

a process of analyzing the above-described history information, attribute information, and permission information that have been received;

a process for producing customer information based on the analysis results of the above-described analysis; and

a process of offering the above-described customer information that has been produced to application execution processor 12Uxy.

Service provider processor 9S in service provider server 100S is equipped with various functions for providing services 11S. For example, service provider processor 9S is equipped with functions for providing service 11S and, when services 11S are to be provided, a function for requesting history utilization agent 8 to obtain the customer information of users Ux, and a function for receiving the customer information of users Ux from history utilization agent 8.

When service 11S is to be provided, history utilization agent 8 in service provider server 100s performs the following processes based on a request from service provider processor 9S:

a process of instructing history extraction agent 6Ux to extract history information;

a process of extracting attribute information and permission information from attribute/permission DB 5Ux;

a process of analyzing the above-described history information, attribute information, and permission information that have been received;

a process of producing customer information based on the analysis results of the above-described analysis; and

a process of providing the above-described customer information that has been produced to service provider processor 9S.

In other words, history utilization agent 8 performs the role of creating customer information of each of users Ux that is necessary for services 11S by way of history extraction agent 6Ux.

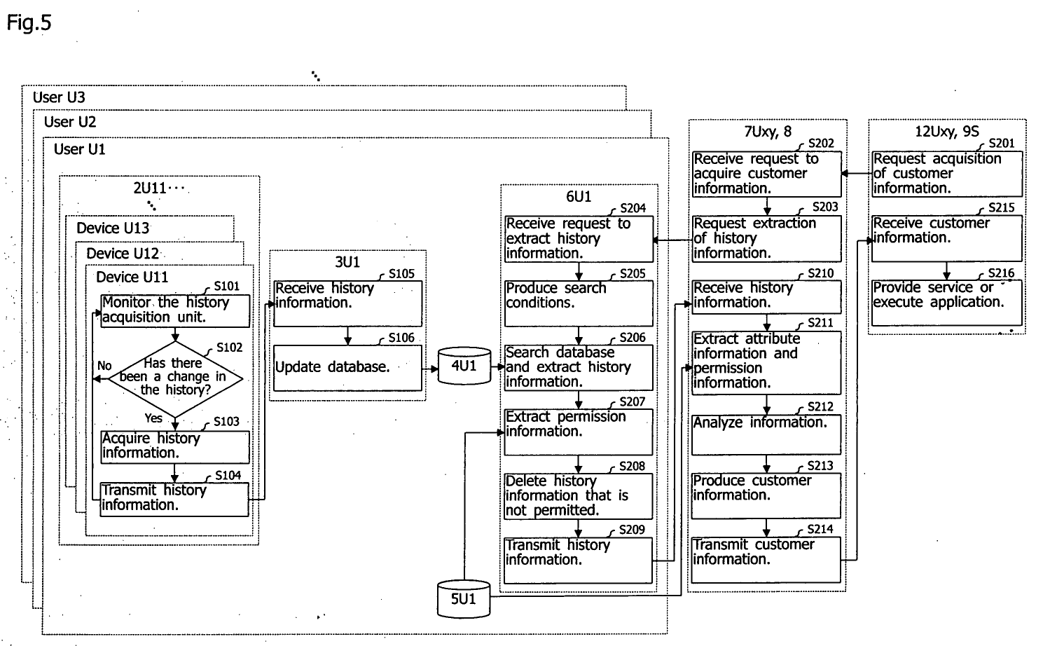

Referring now to FIG. 5, the following explanation regards the operations of the customer information utilization system that is shown in FIG. 1.

(1) Procedure for Acquiring and Storing History Information.

In Step 101, history acquisition agent 2Uxy constantly monitors whether changes have occurred in the history information that is acquired by each history acquisition unit 1Uxy in each device 200Uxy of each user Ux. The history information that each history acquisition unit 1Uxy acquires includes a variety of history information such as the state of use of each device 200Uxy and the state of use of services 11S or applications 10Uxy on each device 200Uxy.

If a change has occurred in history information in Step 102, history acquisition agent 2Uxy acquires the history information in which the change has occurred in Step 103, and transmits the acquired history information to history merge/storage unit 3Ux in Step 104.

In Step 105, history merge/storage unit 3Ux receives the history information that has been transmitted in from history acquisition agent 2Uxy in each device 200Uxy, whereupon, in Step 106, history merge/storage unit 3Ux merges and stores the received history information in history DB 4Ux of each user Ux as shown in FIG. 4. In this way, history merge/storage unit 3Ux updates history DB 4Ux.

(2) Procedure for Utilizing History Information

In Step 201, service provider processor 9S requests history utilization agent 8 to acquire customer information when service 11S is to be provided, or application execution processor 12Uxy requests history utilization agent 7Uxy to acquire customer information when application 10Uxy is to be executed. When issuing the request to acquire customer information at this time, service provider processor 9S and application execution processor 12Uxy designate the extraction conditions that are used in extracting history information and the analysis conditions that are used in the analysis of customer information that is to be provided to its own service 11S or application 10Uxy.

In Step 202, history utilization agents 7Uxy and 8 receive from application execution processor 12Uxy and service provider processor 9S the requests to acquire customer information, whereupon, in Step 203, history utilization agents 7Uxy and 8 first pass on to history extraction agent 6Ux the history information extraction conditions that were designated from application execution processor 12Uxy and service provider processor 9S and request the extraction of history information from history DB 4Ux based on these extraction conditions. At this time, history utilization agents 7Uxy and 8 issue the request to history extraction agent 6Ux that corresponds to the specific user when requesting the extraction of history information of a specific user, and when requesting the extraction of history information of a plurality of nonspecific users, issue the request to history extraction agents 6Ux of each of users Ux.

In Step 204, history extraction agent 6Ux receives from history utilization agents 7Uxy and 8 the requests for extraction of history information, whereupon history extraction agent 6Ux creates history information search conditions that correspond to the extraction conditions that have been passed on from history utilization agents 7Uxy and 8 in Step 205, and in Step 206, searches history DB 4Ux of each user Ux based on the produced search conditions and extracts the history information.

Next, in Step 207, history extraction agent 6Ux extracts from attribute/permission DB 5Ux of each user Ux the permission information that has been designated in advance by each user Ux. In Step 208, history extraction agent 6Ux next deletes, from the history information that has been extracted from history DB 4Ux, the history information that is outside the range permitted by each user Ux based on the permission information that has been extracted from attribute/permission DB 5Ux, and in Step 209, transmits to history utilization agents 7Uxy and 8 that sent in the extraction request only the history information that is within the rage permitted by each user Ux.

In Step 210, history utilization agents 7Uxy and 8 receive the history information from history extraction agent 6Ux, whereupon, in Step 211, history utilization agents 7Uxy and 8 extract from attribute/permission DB 5Ux the attribute information of each user Ux and the permission information that has been designated in advance by each user Ux.

In Step 212, history utilization agents 7Uxy and 8 analyze the history information, attribute information and permission information that were received in Steps 210 and 211 based on the analysis conditions that were designated from application execution processor 12Uxy and service provider processor 9S in Step 201. In Step 213, history utilization agents 7Uxy and 8 produce customer information that is provided to application 10Uxy and service 11S based on the analysis results and transmit the produced customer information to application execution processor 12Uxy and service provider processor 9S in Step 214.

Application execution processor 12Uxy and service provider processor 9S receive the customer information from history utilization agents 7Uxy and 8 in Step 215, whereupon, in Step 216, application execution processor 12Uxy and service provider processor 9S perform processing that reflects the received customer information in service 11S and application 10Uxy and then perform processing to execute application 10Uxy and to provide service 11S.

In FIG. 5, the permission information that was designated by user Ux in advance is also referred to in a case in which customer information is to be provided to application 10Uxy on the side of user Ux. However, restrictions normally do not apply to the provision of customer information for applications 10Uxy on the user Ux side, and it is assumed that the provision of all customer information is permitted. Processes such as the extraction and checking of permission information may therefore be omitted when utilizing customer information in application 10Uxy in FIG. 5.

The following explanations regard specific examples of the utilization of customer information using the customer information utilization system that is shown in FIG. 1.

### Utilization Example 1

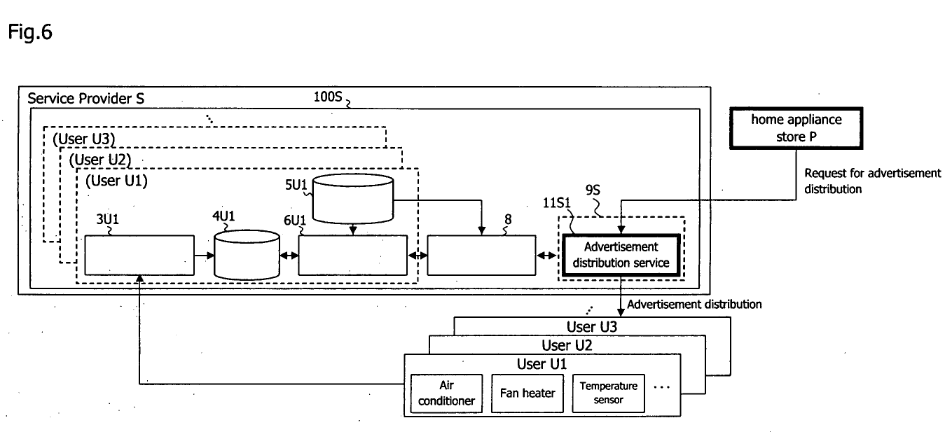

FIG. 6 is a view for explaining a specific example of the utilization of customer information by means of the customer information utilization system that is shown in FIG. 1.

In this utilization example, as an example of utilizing customer information in an e-marketing service, it is assumed that customer information is to be utilized by, of services 11S that are provided by service provider processor 9S in service provider S, a service (referred to as “service 11S1”) that distributes advertisements of specific products under the charge of home appliance store P. In particular, it is here assumed that the specific product is an air conditioner.

In this utilization example, history information such as the purchase history of air conditioners, the history of their use, the frequency of their use, and their repair history is extracted from history DB 4Ux of each user Ux, and this extracted history information is used to produce a user list (customer information) that takes as the targets of advertisement distribution those users for whom the distribution of air conditioner advertising is expected to have a high response, and this customer information is provided to service provider processor 9S. In this way, a more effective advertising distribution service 11S1 can be realized on the service provider processor 9S side.

For example, in the present utilization example, a user list (customer information) can be produced that takes as targets of advertisement distribution those users who are due to buy a new air conditioner and users whose air conditioners are functioning poorly. In such a case, on the side of service provider processor 9S that provides service 11S1, advertising for new air conditioners can be effectively distributed to users who are included in the user list.

Alternatively, in the present utilization example, a user list (customer information) can be prepared that takes as targets of advertisement distribution those users for whom a certain time period has elapsed since the purchase of an air conditioner or users having a high frequency of use of air conditioners. In such a case, advertising for air conditioners that enable lower power consumption can be effectively prepared on the side of service provider processor 9S that provides service 11S1 for distribution to users who are included in the user list.

The following explanation regards the present utilization example with reference to the procedures of FIG. 5 (for the procedures starting with Step 201).

When service provider processor 9S is to provide advertising distribution service 11S, service provider processor 9S first issues in Step 201 a request to acquire customer information to history utilization agent 8, this request designating the extraction conditions that are to be used in the extraction of history information and the analysis conditions that are to be used in the analysis of customer information that is to be provided to its own service 11S1.

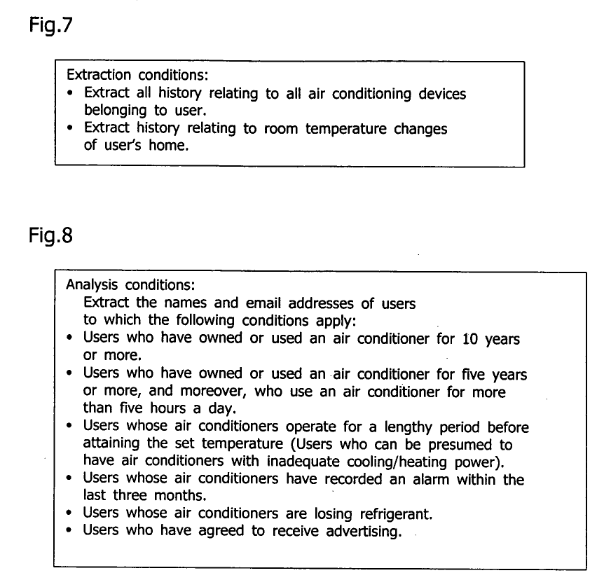

FIG. 7 shows an example of the extraction conditions designated by service provider processor 9S in the present utilization example, and FIG. 8 shows an example of the analysis conditions designated by service provider processor 9S in the present utilization example.

In Step 202, history utilization agent 8 receives the request from service provider processor 9S to acquire customer information, whereupon history utilization agent 8, in Step 203, passes the history information extraction conditions that were designated from service provider processor 9S to history extraction agent 6Ux of each user Ux and requests the extraction of history information from history DB 4Ux based on the extraction conditions.

In Step 204, history extraction agent 6Ux receives the request from history utilization agent 8 to extract history information, whereupon history extraction agent 6Ux, in Step 205, produces history information search conditions that correspond to the extraction conditions that were passed from history utilization agent 8, and in Step 206, searches history DB 4Ux of each user Ux based on the produced search conditions and extracts history information.

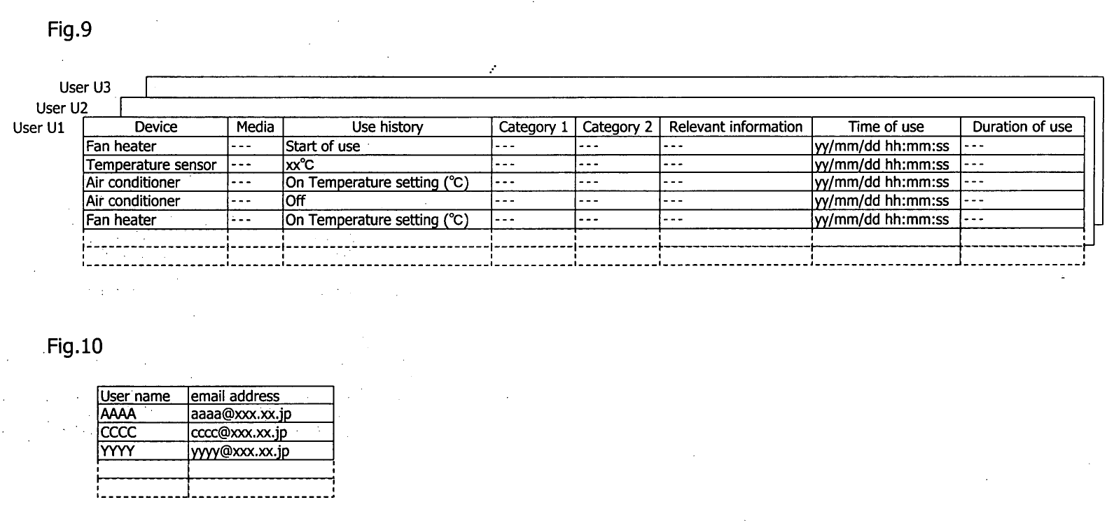

FIG. 9 shows an example of the history information that is extracted from history DB 4Ux by history extraction agent 6Ux in the present utilization example.

Next, in Step 207, history extraction agent 6Ux extracts the permission information from attribute/permission DB 5Ux, deletes history information that is outside the range permitted by users in Step 208, and transmits to history utilization agent 8 only history information that is within the range permitted by users in Step 209.

In Step 210, history utilization agent 8 receives the history information from history extraction agent 6Ux, whereupon history utilization agent 8 extracts the attribute information and permission information of each user Ux from attribute/permission DB 5Ux in Step 211.

In Step 212, history utilization agent 8 next analyzes the history information, attribute information, and permission information that were received in Steps 210 and 211 based on the analysis conditions that were designated from service provider processor 9S in Step 201. History utilization agent 8 then produces a user list (customer information) in Step 213 that takes as targets of advertisement distribution users who are highly likely to respond to the distribution of air conditioner advertising based on the analysis results, and transmits the produced user list to service provider processor 9S in Step 214.

FIG. 10 shows an example of the user list (customer information) that is produced by history utilization agent 8 in the present utilization example.

In Step 215, service provider processor 9S receives the user list from history utilization agent 8, whereupon service provider processor 9S distributes advertisements of air conditioners to the users included in the received user list in Step 216.

In the development of a business such as e-marketing that utilizes the customer information as in the present utilization example, users are believed to be extremely cautious when providing customer information about themselves (in the present invention, attribute information and history information). One reason for this caution is the lack of any foundation for mutual trust between users and service provider S. This lack of trust is believed to arise from two problems, the first being the user's desire to maintain privacy, and the second being the user's concern that even if he or she provides customer information, this customer information will only be utilized by service provider S without the customer being able to receive any compensation for having provided the customer information.

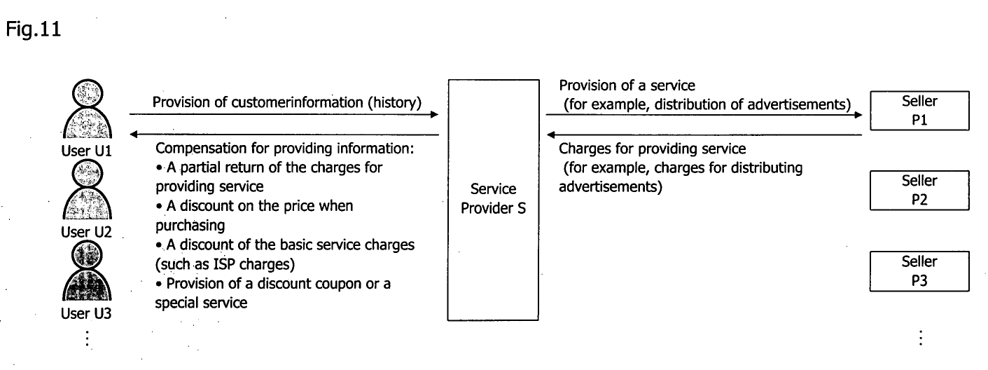

Regarding the first problem, it is believed effective to take measures by which adequate consideration is given to the privacy of users that provide customer information by providing only information that is within a range that the users permit when providing customer information to a service or application, as described hereinabove. Regarding the second problem, it is considered effective to take measures by which users also may obtain some compensation from service provider S for having provided customer information, as shown in FIG. 11. By taking such measures, it is believed that a business such as e-marketing that is described in the present utilization example can be further promoted.

### Utilization Example 2

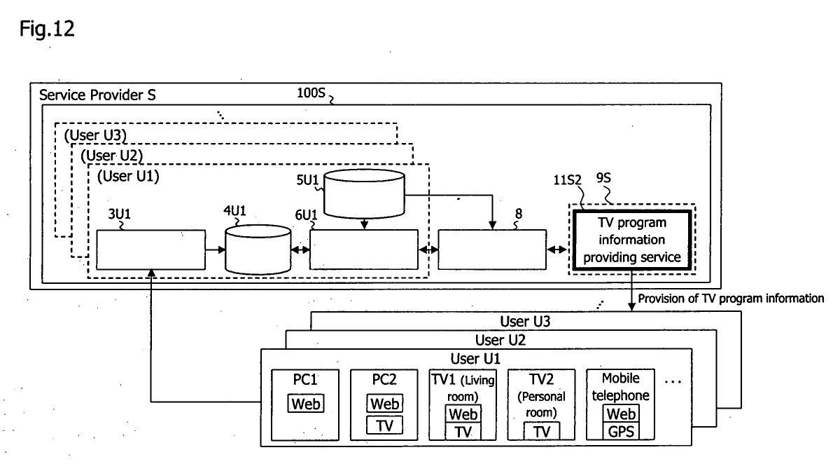

FIG. 12 is a view for explaining a specific utilization example 2 of the utilization of customer information by means of the customer information utilization system that is shown in FIG. 1.

In the present utilization example, it is assumed that, among services 11S that are provided by service provider processor 9S in service provider S, customer information is utilized in a service for providing (recommending) TV program information (referred to as “service 11S2”) to users Ux.

Products already exist that are equipped with a function for providing a service resembling the above-described service. For example, there are products among HDD (Hard Disk Drive) video recorder products that are equipped with the function of guessing a user's interest information based on, for example, the user's TV program recording history and viewing history of recorded TV programs and that automatically record TV programs that appear to match the user's interest information. However, it is difficult to accurately gauge a user's interest information based solely on TV program recording/viewing history. For example, it is difficult to provide a user with TV program information if the user is interested in TV programs on topics that are rarely broadcast.

In the present utilization example, as shown in FIG. 12, not only is TV program recording/viewing history by PC and TV extracted, but, for example, history information of Web accesses by PC, TV, and mobile telephone is also extracted; customer information that accurately gauges a user's interest information is then produced by using the extracted customer information; and this information is then provided to service provider processor 9S. In this way, service 11S2 for providing more suitable TV program information can be realized on the side of service provider processor 9S.

The following explanation regards the procedures of this utilization example with reference to the procedures of FIG. 5 (the utilization procedures that begin with Step 201).

When TV program information providing service 11S2 is to be provided, service provider processor 9S first issues a request in Step 201 to history utilization agent 8 to acquire customer information, this request designating the extraction conditions that are to be used in extracting history information and analysis conditions that are to be used in analyzing the customer information that is to be provided to its own service 11S2.

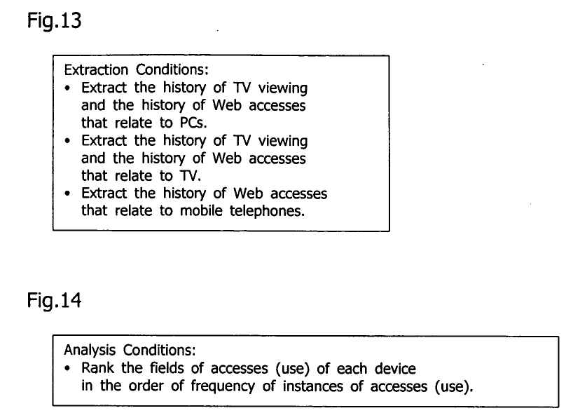

FIG. 13 shows an example of the extraction conditions designated by service provider processor 9S in the present utilization example, and FIG. 14 shows an example of the analysis conditions that are designated by service provider processor 9S in the present utilization example.

In Step 202, history utilization agent 8 receives the request from service provider processor 9S to acquire customer information, whereupon history utilization agent 8, in Step 203, passes on the history information extraction conditions that have been designated from service provider processor 9S to history extraction agent 6Ux of each user Ux that receives service 11S2, and requests the extraction of history information from history DB 4Ux based on these extraction conditions.

In Step 204, history extraction agent 6Ux receives the request from history utilization agent 8 to extract history information, whereupon history extraction agent 6Ux produces history information search conditions in Step 205 that correspond to the extraction conditions that have been passed from history utilization agent 8, and, in Step 206, searches history DB 4Ux of user Ux based on the produced search conditions and extracts history information.

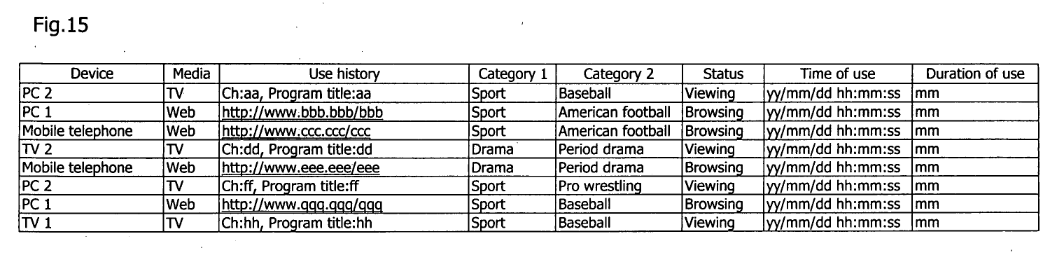

FIG. 15 shows an example of history information that is extracted from history DB 4Ux by history extraction agent 6Ux in the present utilization example.

In Step 207, history extraction agent 6Ux next extracts permission information from attribute/permission DB 5Ux of user Ux, deletes history information that is outside the range permitted by the user in Step 208, and transmits to history utilization agent 8 only history information that is within the range permitted by the user in Step 209.

In Step 210, history utilization agent 8 receives the history information from history extraction agent 6Ux, whereupon history utilization agent 8 extracts the attribute information and permission information of user Ux from attribute/permission DB 5Ux in Step 211.

In Step 212, history utilization agent 8 next analyzes the history information, attribute information, and permission information that have been received in Steps 210 and 211 based on the analysis conditions that were designated from service provider processor 9S in Step 201.

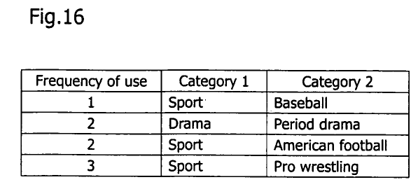

FIG. 16 shows an example of the analysis results of the analysis of the history information, attribute information, and permission information by history utilization agent 8.

According to FIGS. 15 and 16, by analyzing the history information of a plurality of devices, history utilization agent 8 is able to gauge a user's degree of interest for various products to an extent that cannot be comprehended by analyzing the history information of a single device such as TV.

For example, based on FIG. 15 and FIG. 16, it can be understood that a particular user is most interested in baseball, and that, based on numerous instances of viewing on the Web, the user is highly likely to have an interest in American football, for which there is no actual TV viewing record.

Thus, by analyzing the history information of a plurality of devices, history utilization agent 8 can accurately gauge the interest information of a user that cannot be comprehended from only the history information of a single device such as TV.

In Step 213, history utilization agent 8 next produces customer information from the accurate assessment of the interest information of the user based on analysis results as shown in FIG. 16, and in Step 214, transmits the produced customer information to service provider processor 9S.

Service provider processor 9S then receives the customer information from history utilization agent 8 in Step 215, whereupon service provider processor 9S provides the TV program information based on the received customer information in Step 216.

In this case, service provider processor 9S is able to provide TV program information that accurately gauges the interest information of the user. In this way, service provider processor 9S can, for example, provide not only baseball program information in advance, but can provide program information in advance for American football, for which there had been no actual TV viewing record.

### Utilization Example 3

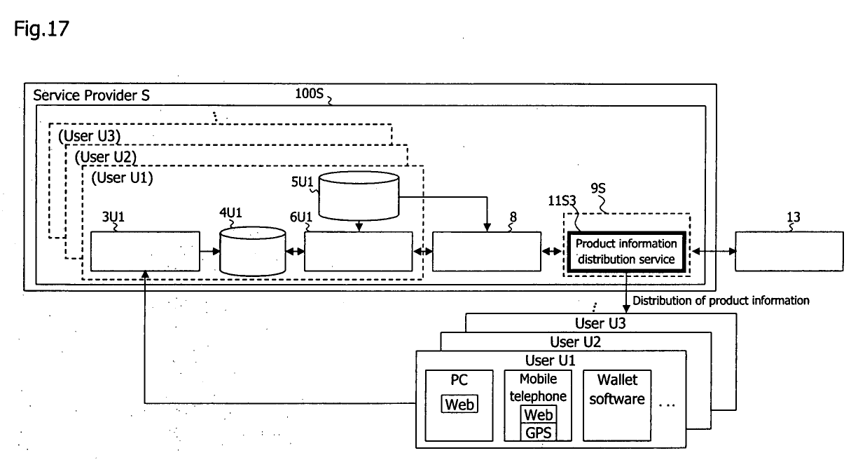

FIG. 17 is a view for explaining a specific utilization example 3 of the utilization of customer information by means of the customer information utilization system that is shown in FIG. 1.

In the present utilization example, it is assumed that customer information is utilized in a service (referred to as “service 11S3”) among the various services 11S provided by service provider processor 9S in service provider S in which product information (or advertisements) is distributed to users Ux.

In the present utilization example, it is assumed that users Ux perform searches regarding a variety of products by accessing the Web from, for example, a PC or a mobile telephone among each of devices 200Uxy belonging to the user. It is further assumed that a mobile telephone, which is one of devices 200Uxy belonging to user Ux, is equipped with a position acquiring function such as GPS (Global Positioning System). In addition, position information server 13 is also provided that is linked with the position-acquiring function of the mobile telephone for acquiring information of actual physical stores that user Ux has visited. Still further, when visiting and shopping at an actual physical store, user Ux buys products using a means such as wallet software that is capable of recording an account.

The following explanation regards the procedures of the present utilization example with reference to the procedures (the utilization procedures starting with Step 201) of FIG. 5.

When product information distribution service 11S3 is to be provided, service provider processor 9S first issues a request to history utilization agent 8 in Step 201 to acquire customer information, and designates in this request the extraction conditions that are to be used in extracting history information and analysis conditions that are to be used in analyzing the customer information that is to be provided to its own service 11S3.

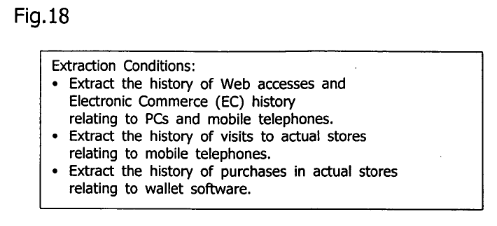

FIG. 18 shows an example of the extraction conditions that are designated by service provider processor 9S in the present utilization example.

In Step 202, history utilization agent 8 receives from service provider processor 9S the request for acquisition of customer information, whereupon history utilization agent 8, in Step 203, passes the history information extraction conditions that have been designated from service provider processor 9S to history extraction agent 6Ux of user Ux that receives the provided service 11S3, and requests the extraction of history information from history DB 4Ux based on these extraction conditions.

In Step 204, history extraction agent 6Ux receives the request from history utilization agent 8 to extract history information, whereupon history extraction agent 6Ux produces history information search conditions that correspond to the extraction conditions that have been passed from history utilization agent 8 in Step 205, and in Step 206, searches history DB 4Ux of user Ux based on the search conditions that have been produced and extracts history information.

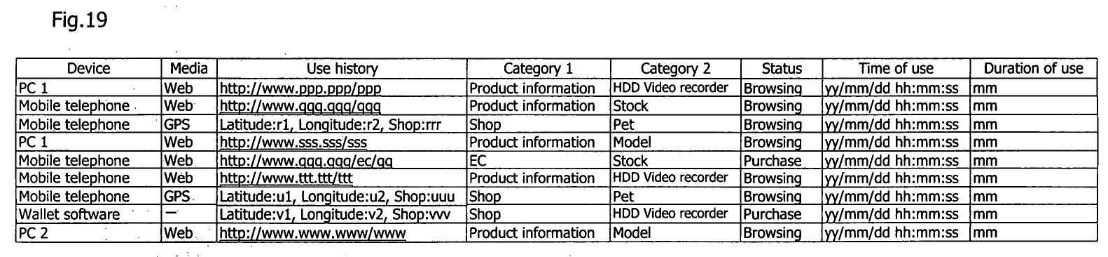

FIG. 19 shows an example of the history information that is extracted from history DB 4Ux by history extraction agent 6Ux.

In Step 207, history extraction agent 6Ux next extracts permission information from attribute/permission DB 5Ux of user Ux, deletes the history information that is outside the range permitted by the user in Step 208, and transmits to history utilization agent 8 only the history information that is within the range permitted by the user in Step 209.

History utilization agent 8 receives the history information from history extraction agent 6Ux in Step 210, whereupon history utilization agent 8 extracts the attribute information and permission information of user Ux from attribute/permission DB 5Ux in Step 211.

Next, in Step 212, history utilization agent 8 analyzes the history information, attribute information, and permission information that have been received in Steps 210 and 211 based on the analysis conditions that were designated from service provider processor 9S in Step 201.

As shown in FIG. 19, by analyzing a plurality of items of history information, history utilization agent 8 is able to gauge the user's degree of interest with respect to each product to an extent that would not be possible by analyzing a single item of history information, such as Web access.

For example, as shown in FIG. 19, an analysis of a plurality of items of history information first reveals that a particular user has an interest in stocks, pets, and models. History utilization agent 8 is thus able to accurately comprehend the interest information of the user by analyzing the plurality of items of history information.

In addition, the behavior of a particular user when purchasing particular specialty items (other than products for daily use) often changes from a desire for product information (including advertisement information) when in the stage of searching for a product to a desire for information on how to use or care for the product after having purchased the product. In such a case, product information that continues to be distributed after the product has been purchased is highly likely to be perceived as only annoying by the user.

For such a case, history extraction agent 6Ux extracts history information relating to, for example, history regarding the purchase of an HDD video recorder that includes not only the purchase history by means of Web access but also the purchase history in actual stores, as shown in FIG. 19. History utilization agent 8 can thus accurately gauge the actions taken by a user when purchasing the product.

Next, having accurately gauged the interest information of user Ux and the actions taken by user Ux when purchasing products based on the analysis results obtained from analyzing the history information such as shown in FIG. 19, history utilization agent 8 produces customer information In Step 213, and transmits the produced customer information to service provider processor 9S in Step 214.

Service provider processor 9S receives the customer information from history utilization agent 8 in Step 215, whereupon service provider processor 9S distributes product information based on the received customer information in Step 216.

Service provider processor 9S is here able to distribute product information that accurately gauges the interest information of the user and the actions taken by the user when purchasing products, and is therefore able to distribute timely product information that is desired by the user.

### Utilization Example 4

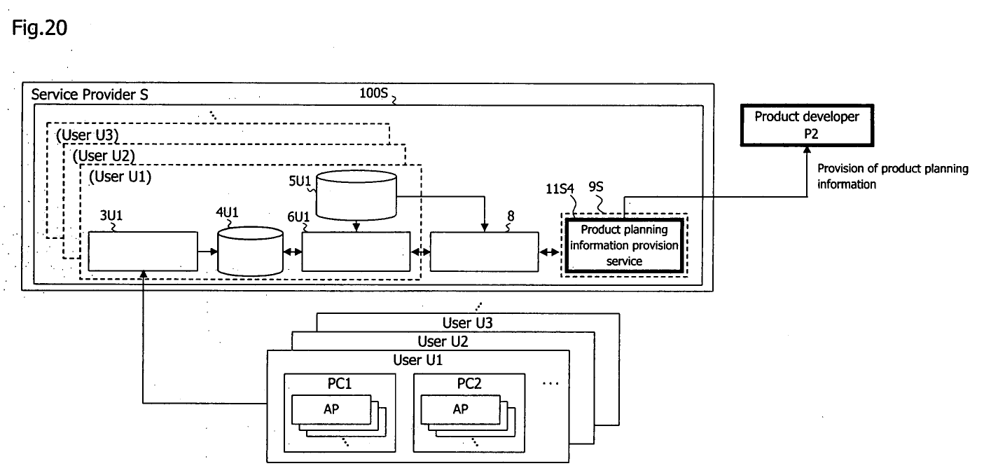

FIG. 20 is a view for explaining specific utilization example 4 of the utilization of customer information by means of the customer information utilization system that is shown in FIG. 1.

In the present utilization example, it is assumed that customer information is utilized in a service (referred to as “service 11S4”) among services 11S that are provided by service provider processor 9S in service provider S, this service 11S4 providing planning information for specific products to product developers P2 based on requests from product developers P2.

In the following explanation, a case is assumed in which, as product planning information provider service 11S4, customer information for planning a PC product is provided as product planning information to product developers P2 based on the requests from PC product developers P2. Product developers P2 need information on which types of application software are most often used by users Ux in order to bundle more popular application software with a PC that is to be offered as a new product.

The following explanation regards the procedures of the present utilization example with reference to the procedures of FIG. 5 (procedures that start with Step 201).

When product planning information provider service 11S4 is to be provided based on requests from product developers P2, service provider processor 9S performs processing for obtaining information (customer information) on the state of use of application software of each of users Ux. Here, service provider processor 9S first issues a request to history utilization agent 8 to acquire customer information, this request designating the extraction conditions that are to be used in extracting history information and the analysis conditions that are to be used when analyzing the customer information that is to be provided to its own service 11S4.

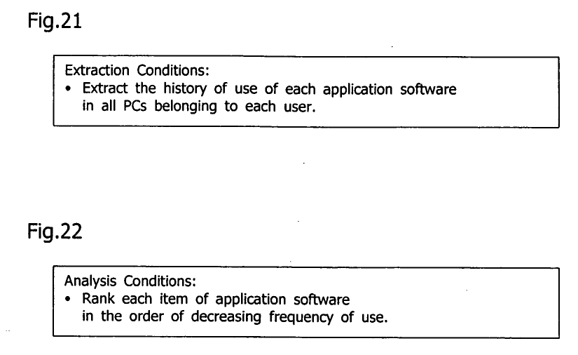

FIG. 21 shows an example of the extraction conditions that are designated by service provider processor 9S in the present utilization example, and FIG. 22 shows an example of the analysis conditions that are designated by service provider processor 9S in the present utilization example.

History utilization agent 8 receives the request from service provider processor 9S to acquire customer information in Step 202, whereupon history utilization agent 8, in Step 203, passes on the history information extraction conditions that have been designated by service provider processor 9S to history extraction agent 6Ux of each of users Ux and requests the extraction of history information from history DB 4Ux based on these extraction conditions.

History extraction agent 6Ux receives the history information extraction request from history utilization agent 8 in Step 204, whereupon history extraction agent 6Ux produces history information search conditions that correspond to the extraction conditions that have been passed from history utilization agent 8 in Step 205, and searches history DB 4Ux of each user Ux based on the produced search conditions and thus extracts history information in Step 206.

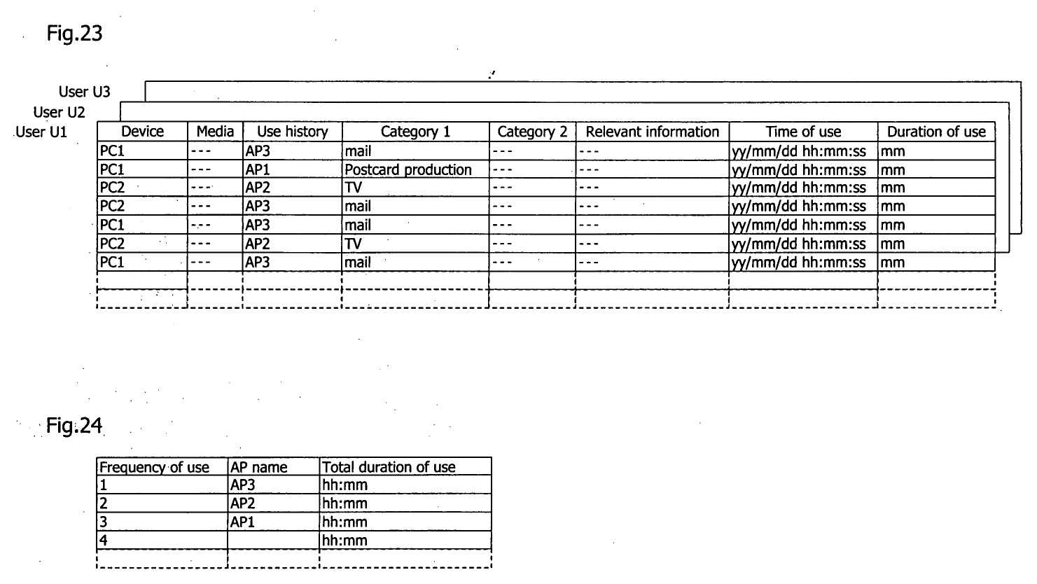

FIG. 23 shows an example of the history information that is extracted from history DB 4Ux by history extraction agent 6Ux in the present utilization example.

History extraction agent 6Ux next extracts permission information from attribute/permission DB 5Ux of each user Ux in Step 207, deletes history information that is outside the range that is permitted by the users in Step 208, and transmits to history utilization agent 8 only history information that is within the range that is permitted by the users in Step 209.

History utilization agent 8 receives the history information from history extraction agent 6Ux in Step 210, whereupon history utilization agent 8 extracts attribute information and permission information of each user Ux from attribute/permission DB 5Ux in Step 211.

In Step 212, history utilization agent 8 next analyzes the history information, attribute information, and permission information that were received in Steps 210 and 211 based on the analysis conditions that were designated by service provider processor 9S in Step 201. History utilization agent 8 then produces information (customer information) on the state of use of application software based on the analysis results in Step 213, and transmits the produced information to service provider processor 9S in Step 214.

FIG. 24 shows an example of the information on the state of use of application software that is produced by history utilization agent 8 in the present utilization example.

Service provider processor 9S next receives the information on the state of use of application software from history utilization agent 8 in Step 215, whereupon service provider processor 9S provides the received information to product developers P2 in Step 216.

In the present utilization example, product developers P2 can determine which application software to bundle with a PC based on information regarding which application software is actually being used by each user Ux and the degree of use of the application software, and as a result, a more marketable PC can be planned.

The explanation of the present utilization example regarded a case of providing information relating to the state of use of application software on a PC, but since the necessary history information is extracted at the time of providing the service in the present invention, it is easily possible to provide other product planning information.

Second Embodiment

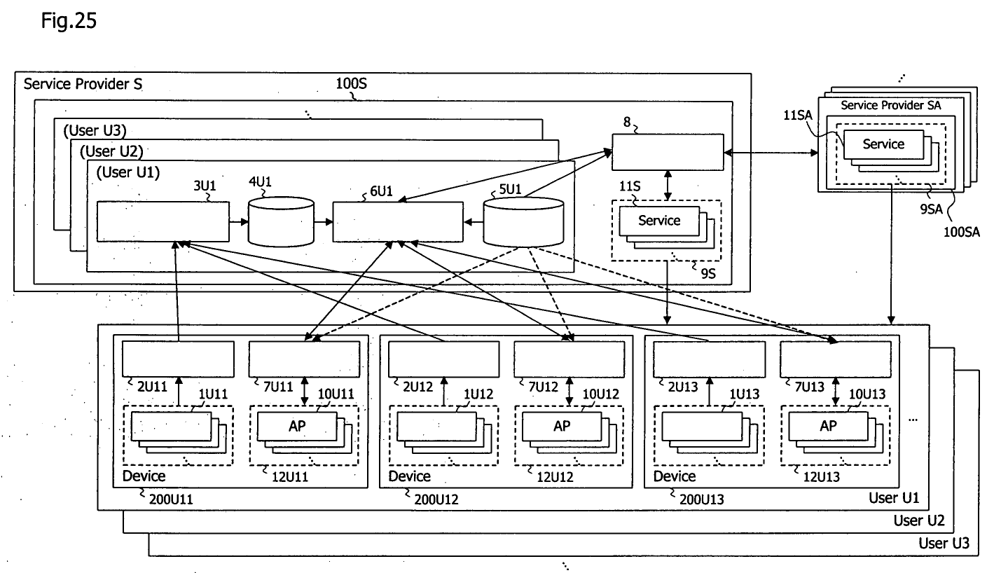

FIG. 25 shows the configuration of the customer information utilization system according to the second embodiment of the present invention.

Referring to FIG. 25, the customer information utilization system according to the second embodiment of the present invention differs from the configuration of the first embodiment that was shown in FIG. 1 in that service provider server 100SA is provided that belongs to another service provider SA. Service provider server 100SA need not be a single physical server, and may be constituted by a plurality of physical servers for such purposes as distributing load or dividing functions.

Service provider server 100SA provides one or more services 11SA that utilize the customer information of each user Ux, and can be realized by a typical information processing device such as a server, a PC, or a supercomputer. Service provider server 100SA is equipped with service provider processor 9SA that corresponds to the first customer information request means. This service provider processor 9SA is provided with various functions for providing services 11SA. For example, service provider processor 9SA is equipped with a function for providing service 11SA, a function for issuing a request to history utilization agent 8 to acquire customer information of users Ux when service 11SA is to be provided, and a function for receiving customer information of users Ux from history utilization agent 8. Service provider server 100SA may be of any configuration that is equipped with service provider processor 9SA, and for example, may include the same constituent elements as service provider server 100S.

The present embodiment has the merit that, when service provider processor 9SA in service provider server 100SA is to provide service 11SA, customer information may be produced by using history information that is required by another service provider SA upon receiving a request from service provider processor 9SA for acquisition of customer information, and the produced customer information then provided.

Third Embodiment

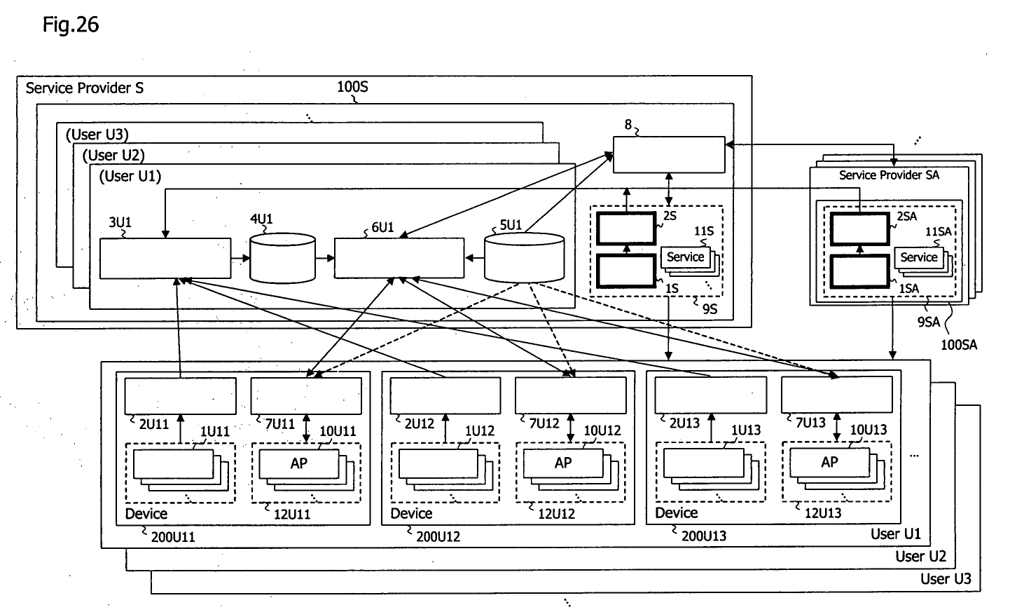

FIG. 26 shows the configuration of the customer information utilization system according to the third embodiment of the present invention.

Referring to FIG. 26, the customer information utilization system of the third embodiment of the present invention differs from the configuration of the second embodiment that is shown in FIG. 25 in that history acquisition units 1S and 1SA and history acquisition agents 2S and 2SA are also arranged on the sides of service provider servers 100S and 100SA.

In the present embodiment, history merge/storage unit 3Ux features the ability to collect history information that can only be obtained by service providers S and SA (history information that cannot be obtained at each of devices 200Uxy of each of users Ux).

Fourth Embodiment

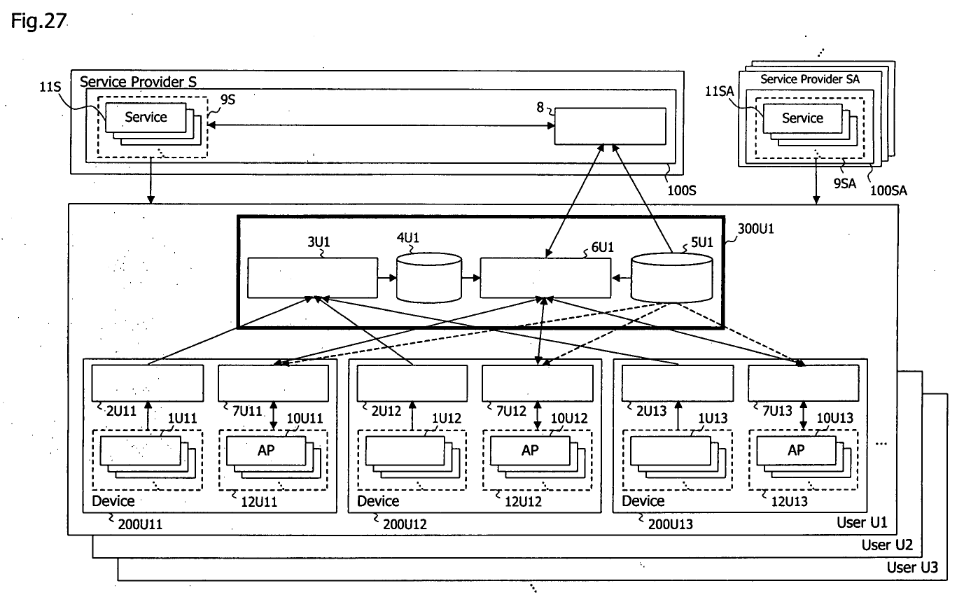

FIG. 27 shows the configuration of the customer information utilization system according to the fourth embodiment of the present invention.

Referring to FIG. 27, the customer information utilization system according to the fourth embodiment of the present invention differs from the configuration of the second embodiment that is shown in FIG. 25 in that history merge/storage unit 3Ux, history DB 4Ux, attribute/permission DB 5Ux, and history extraction agent 6Ux of each user Ux are arranged in user server 300Ux that belongs to each user. In addition, user server 300Ux can be realized by a typical information processor such as a home server or PC.

In the present embodiment, the history information of each user Ux is stored on the side of user server 300Ux. As a result, history extraction agent 6Ux refers to attribute/permission DB 5Ux and passes on to service providers S and SA only the history information that is within the range that is permitted by each user Ux. This form is advantageous because users Ux will have less resistance to the acquisition and storage of the various history information of devices 200Uxy that belong to the user.

In contrast, in the second embodiment that is shown in FIG. 25, of the history information of devices 200Uxy that belong to each user Ux, the history information that is actually utilized is history information that is within the range that is permitted by each user Ux. However, all of the history information is stored in service provider server 100S of service provider S, and each user Ux may therefore feel some unease.

In the present embodiment, moreover, the storage of the history information of each user Ux on the side of user server 300Ux allows a limitation of the use of the resources of service provider server 100S of service provider S.

In the present invention, various types of history information of devices 200Uxy that belong to each user Ux are stored. Thus, when all of the history information is stored in one place, such as in service provider server 100S as in the second embodiment that is shown in FIG. 25, there arises the strong possibility that the necessary storage capacity in service provider server 100S will become voluminous and the equipment of service provider S will be subjected to undue pressure. On the other hand, the storage capacity that is incorporated in home servers or PCs that realize user servers 300Ux has become quite massive in recent years and is easily sufficient for saving only the history information of each user Ux. The adoption of a configuration such as the present embodiment therefore is not considered likely to overtax the equipment of service provider S or to overburden the equipment of each user Ux.

In addition, it is also possible for one of devices 200Uxy of each user Ux to also function as server 300Ux.

Fifth Embodiment

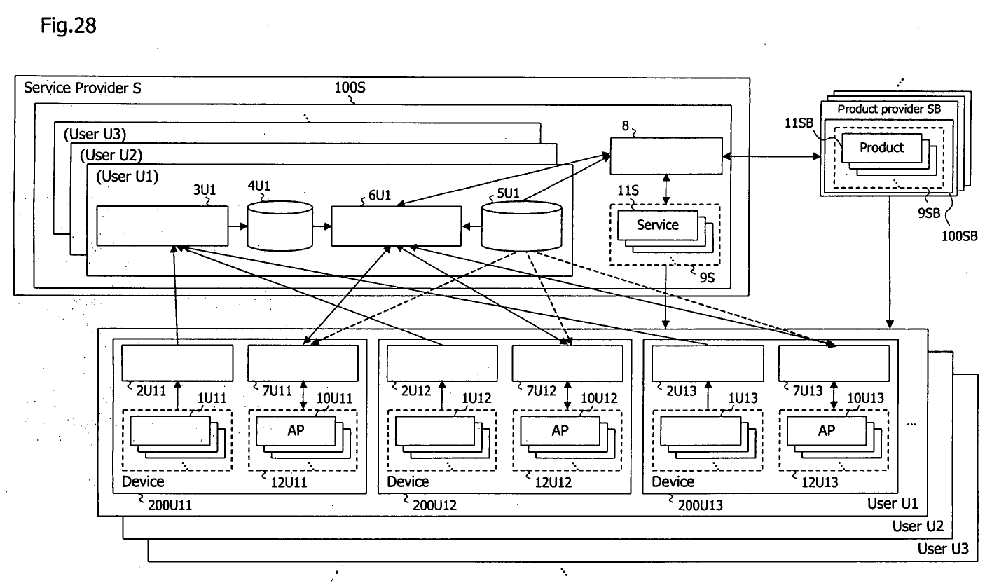

FIG. 28 shows the configuration of the customer information utilization system according to the fifth embodiment of the present invention.

Referring to FIG. 28, the customer information utilization system according to the fifth embodiment of the present invention differs from the configuration of the second embodiment that is shown in FIG. 25 in that information processor 100SB that belongs to product provider SB is provided instead of another service provider server 100SA. In addition, information processor 100SB need not be one physical server, and may, for the purpose of distributing load and dividing functions, be constituted by a plurality of physical servers.

Information processor 100SB is utilized for providing one or more products 11SB and can be realized by a typical information processor such as a server, a PC or a supercomputer. In addition, the customer information of each user Ux can be utilized on the side of information processor 100SB for the purpose of being reflected in the provision, planning, and promotion of product 11SB. Information processor 100SB is equipped with product provider processor 9SB, which corresponds to the first customer information request means. This product provider processor 9SB is equipped with various functions for supporting the provision of various products 11SB. For example, when product provider SB is to provide product 11SB, product provider processor 9SB is equipped with a function for issuing a request to history utilization agent 8 to acquire customer information of user Ux and a function for receiving the customer information of user Ux from history utilization agent 8. Information processor 100SB may have any configuration that is equipped with product provider processor 9SB, and for example, may include the same constituent elements as service provider server 100S.

The present embodiment has the advantage of, when product provider SB is to provide product 11SB, enabling: reception of a request from product provider processor 9SB to acquire customer information, use of history information that is required by product provider SB to produce customer information, and provision of the produced customer information.

While preferred embodiments of the present invention have been described using specific terms, such description is for illustrative purposes only, and it is to be understood that changes and variations may be made without departing from the spirit or scope of the following claims.

What is claimed is:

1. A customer information utilization system for utilizing customer information of users in a product, service, or application, said customer information utilization system comprising:
a first customer information request means for, when said product or said service is to be provided, issuing a request for acquisition of customer information of said users;
a second customer information request means for, when said application is to be executed on each device belonging to said users, issuing a request for acquisition of customer information of said users; and
a history utilization means for, upon receiving a request for acquisition of customer information of said users from said first customer information request means or said second customer information request means, using appropriate history information of history information that relates to the history of use of each device belonging to said users to produce customer information that is utilized in said product, said service, or said application.

2. A customer information utilization system according to claim 1, comprising:
a history acquisition means that is arranged in each device belonging to said users for acquiring history information that relates to the history of use of the device; and
a history storage means for collecting, by way of said history acquisition means that is arranged in each device belonging to said users, history information that relates to the history of use of the device and storing the history information; wherein said history utilization means, upon receiving a request for acquisition of customer information of said users from said first customer information request means or said second customer information request means, extracts appropriate history information of the history information that is stored in said history storage means, and produces said customer information based on the extracted history information.

3. A customer information utilization system according to claim 2, wherein said history storage means is provided for each of said users, and, by way of said history acquisition means that is arranged in each device belonging to a relevant user, collects and stores history information relating to the history of use of that device.

4. A customer information utilization system according to claim 2, wherein said history utilization means includes:
a first history utilization means that is arranged in an information processor that belongs to the provider of said product or said service; and
a second history utilization means that is arranged in each device that is a device belonging to said users and that executes a relevant application.

5. A customer information utilization system according to claim 2, comprising:
a first storage means for storing history information relating to the history of use of each device belonging to said users based on instructions of said history storage means; and
a history extraction means for extracting history information relating to the history of use of each device belonging to said users from said first storage means; wherein:
said history utilization means, upon receiving from said first customer information request means or said second customer information request means a request to acquire customer information of said users, extracts history information from said first storage means by way of said history extraction means.

6. A customer information utilization system according to claim 5, wherein:
said first storage means is provided for each of said users for storing history information relating to the history of use of each device belonging to a relevant user based on the instructions of said history storage means; and
said history extraction means is provided for each of said users for extracting from said first storage means history information that relates to the history of use of each device belonging to a relevant user.

7. A customer information utilization system according to claim 5, wherein:
said history utilization means, upon receiving from said first customer information request means or said second customer information request means a request to acquire customer information of said users, passes on to said history extraction means history information extraction conditions that have been instructed from the first customer information request means or the second customer information request means; and
said history extraction means extracts history information from said first storage means based on the extraction conditions that have been passed from said history utilization means, and passes the extracted history information to said history utilization means.

8. A customer information utilization system according to claim 5, comprising:
a second storage means for storing permission information that indicates, of the history information relating to the history of use of each device belonging to said users, the range of the history information that said users permit for provision; wherein:
based on permission information that is extracted from said second storage means, said history extraction means passes on to said history utilization means, of the history information that is extracted from said first storage means, only history information that is within the range that is permitted by said users.

9. A customer information utilization system according to claim 8, wherein:
said second storage means is provided for each of said users for storing permission information that indicates, of history information relating to the history of use of each device belonging to the relevant user, the range of history information that the user permits for provision.

10. A customer information utilization system according to claim 8, wherein:
said history utilization means, upon receiving from said first customer information request means or said second customer information request means a request to acquire customer information of said users, analyzes history information that has been passed on from said history extraction means based on analysis conditions that are instructed from the first customer information request means or the second customer information request means and produces said customer information based on the analysis results.

11. A customer information utilization system according to claim 8, wherein:
said second storage means stores attribute information of said users and permission information that indicates, of said attribute information, the range of attribute information that relevant users permits for provision; and
said history utilization means, upon receiving from said first customer information request means or said second customer information request means a request to acquire customer information of said users, analyzes said history information that has been passed from said history extraction means and attribute information and permission information that have been extracted from said second storage means based on analysis conditions that have been instructed from the first customer information request means or the second customer information request means, and produces said customer information based on analysis results.

12. A customer information utilization system according to claim 8, wherein:
said history storage means; said first and second storage means, and said history extraction means are arranged in an information processor that belongs to the provider of said product or said service.

13. A customer information utilization system according to claim 8, wherein:
said history storage means, said first and second storage means, and said history extraction means are arranged in information processors that belong to said users.

14. An information processor that belongs to a provider of a product or a service, said information processor comprising:
a customer information request means for issuing a request to acquire customer information of users when said product or said service is to be provided; and
a history utilization means for, upon receiving from said customer information request means a request to acquire customer information of said users, using appropriate history information of history information relating to the history of use of each device belonging to said users to produce customer information that is to be utilized in said product or said service.

15. An information processor according to claim 14, comprising:
a history storage means for collecting history information relating to the history of use of each device belonging to said users from the devices and storing said history information; wherein:
said history utilization means, upon receiving from said customer information request means a request to acquire customer information of said users, extracts appropriate history information from said stored history information and produces said customer information based on extracted history information.

16. An information processor according to claim 15, wherein:
said history storage means is provided for each of said users for collecting history information relating to the history of use of each device belonging to said users from the devices and storing said history information.

17. An information processor according to claim 15, comprising:
a first storage means for storing history information relating to the history of use of each device belonging to said users based on instructions of said history storage means; and
a history extraction means for extracting, from said first storage means, history information relating to the history of use of each device belonging to said users; wherein:
said history utilization means, upon receiving from said customer information request means a request to acquire customer information of said users, extracts history information from said first storage means by way of said history extraction means.

18. An information processor according to claim 17, wherein:
said first storage means is provided for each of said users for storing history information relating to the history of use of each device belonging to said users based on instructions of said history storage means; and
said history extraction means is provided for each of said users for extracting from said first storage means history information relating to the history of use of each device belonging to said users.

19. An information processor according to claim 17, wherein:
said history utilization means, upon receiving from said customer information request means a request to acquire customer information of said users, passes to said history extraction means extraction conditions that have been instructed from the customer information request means; and
said history extraction means extracts history information from said first storage means based on the extraction conditions that have been passed from said history utilization means and passes the extracted history information to said history utilization means.

20. An information processor according to claim 17, comprising:
a second storage means for storing permission information that indicates, of history information relating to the history of use of each device belonging to said users, the range of history information that said users permit for provision; wherein:
based on permission information that has been extracted from said second storage means, said history extraction means passes to said history utilization means, of history information that has been extracted from said first storage means, only history information that is within the range permitted by said users.

21. An information processor according to claim 20, wherein:
said second storage means is provided for each of said users for storing permission information that indicates, of history information relating to the history of use of each device belonging to the user, the range of history information that the user permits for provision.

22. An information processor according to claim 20, wherein:
said history utilization means, upon receiving from said customer information request means a request to acquire customer information of said users, analyzes history information that has been passed from said history extraction means based on analysis conditions that are instructed from said customer information request means and produces said customer information based on analysis results.

23. An information processor according to claim 20, wherein:
a said second storage means stores attribute information of said users and permission information that indicates, of said attribute information, the range of attribute information that the users permit for provision; and
said history utilization means, upon receiving a request from said customer information request means to acquire customer information of said users, analyzes said history information that has been passed from said history extraction means and attribute information and permission information that have been extracted from said second storage means based on analysis conditions that are instructed from the customer information request means and produces said customer information based on analysis results.

24. Devices that belong to users for executing an application in said devices, said devices each comprising:
a customer information request means for issuing a request to acquire customer information of said users when said application is to be executed; and
a history utilization means for, upon receiving a request from said customer information request means to acquire customer information of said users, using appropriate history information of history information relating to the history of use of each device that includes the relevant devices that belong to said users to produce customer information that is utilized in said application.

25. Devices according to claim 24, each of said devices comprising:
a history acquisition means for acquiring history information relating to the history of use of its own device and transmitting the acquired history information to a prescribed information processor; wherein:
said history utilization means, upon receiving a request from said customer information request means to acquire customer information of said users, extracts appropriate history information by way of said prescribed information processor, and produces said customer information based on the extracted history information.

26. Devices according to claim 25, wherein:
said history utilization means, upon receiving a request from said customer information request means to acquire customer information of said users, passes history information extraction conditions that are instructed from the customer information request means to said prescribed information processor to cause the extraction of history information based on said extraction conditions.

27. Devices according to claim 25, wherein:
said history utilization means, upon receiving a request from said customer information request means to acquire customer information of said users, analyzes said history information based on analysis conditions that are instructed from said customer information request means and produces said customer information based on analysis results.
